(19) United States
(12) Patent Application Publication
(10) Pub. No.: US 2012/0290712 A1
(43) Pub. Date: Nov. 15, 2012

(54) Account Compromise Detection

(75) Inventors: Jason D. Walter, San Jose, CA (US); Krishna Vitaldevara, Fremont, CA (US); John D. Rodrigues, Mountain House,, CA (US)

(73) Assignee: MICROSOFT CORPORATION, Redmond, WA (US)

(21) Appl. No.: 13/107,129

(22) Filed: May 13, 2011

(51) Int. Cl. G06F 15/173

(52) U.S. Cl. 709/224

(57) ABSTRACT

Techniques for account compromise detection are described. In one or more implementations, a usage pattern is established for a user account of a service provider, where the service provider is configured to provide a plurality of web services for access via a network and the usage pattern describes interaction with one or more of the plurality of web services. A deviation is detected in subsequent activity associated with the user account from the usage pattern and a determination is made as to whether compromise the user account is likely based at least in part on the detection.

### BACKGROUND

The compromise of user accounts by malicious parties is an increasingly significant problem faced by service providers, e.g., web services, because the techniques used by attackers and spammers are increasingly complex. Compromised user accounts can then be used for a variety of malicious activities, such as to send phishing or spam messages to other users on a contact list.

Often, these phishing or spamming campaigns occur without user knowledge, and it can be difficult to identify whether an account has been compromised due to an increasingly complex “hidden” nature of the attacks. Traditional techniques that were used to identify suspicious activity within a user account, however, may not be sufficient to identify “hidden” suspicious activity and/or the malicious parties involved in the compromise of user accounts.

### SUMMARY

Techniques for account compromise detection are described. In one or more implementations, a usage pattern is established for a user account of a service provider, where the service provider is configured to provide a plurality of web services for access via a network and the usage pattern describes interaction with one or more of the plurality of web services. A deviation is detected in subsequent activity associated with the user account from the usage pattern and a determination is made as to whether compromise of the user account is likely based at least in part on the detection.

In one or more implementations, activity associated with a user account of a service provider is monitored to establish a usage pattern for the user account, the service provider configured to provide a plurality of web services for access via a network, and the usage pattern indicating one or more of the plurality of web services that are accessed via the network and one or more interfaces that are used to access respective said web services. Subsequent activity associated with the user account is compared with the usage pattern. A deviation is determined in the subsequent activity from the usage pattern, the deviation indicating an increase in frequency of use in one or more of the interfaces in comparison with the usage pattern. It is determined whether compromise of the user account is likely based at least in part on the deviation.

In one or more implementations, a compromise detection module is configured to compare an established usage pattern associated with a user account of a service provider to subsequent activity associated with the user account. The service provider is configured to provide a plurality of web services for access via a network and the established usage pattern indicates one or more of the plurality of web services that are accessed via the network. The compromise detection module is further configured to detect, in the subsequent activity, an increase in the volume of usage of one or more of the web services based on the established usage pattern. The compromise detection module is further configured to determine whether compromise of the user account is likely based at least in part on the detection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques for account compromise detection.

FIG. 2 is an illustration of a of an example implementation that is operable to employ account compromise detection techniques.

FIG. 3 is a flow diagram depicting a procedure in an example implementation of account compromise detection in which a deviation from a usage pattern is used to determine whether a compromise of the user account has occurred.

FIG. 4 is a flow diagram depicting a procedure in an example implementation of account compromise detection in which activity is monitored and used to determine a deviation from a usage pattern.

### DETAILED DESCRIPTION

Overview

The compromise of user accounts by malicious parties is an increasingly significant problem faced by service providers, e.g., web services. Traditional techniques that were used to identify suspicious activity within a user account, however, may not be sufficient to identify “hidden” suspicious activity and/or the malicious parties involved in the compromise of user accounts. This may make it difficult to identify whether an account has been compromised.

Techniques for account compromise detection are described. In one or more implementations, a usage pattern is established for a user account of a service provider. The usage pattern may identify a pattern of user activity within the user account. Responsive to detecting a deviation in subsequent activity from the usage pattern, a determination may be made as to a likelihood that the user account has been compromised. For example, the usage pattern may show that a user frequently accesses a messenger service via a service provider but subsequent activity may show a substantial increase in use of an email service. Thus, this may serve as a basis of determining a likelihood that the user account has been compromised by a malicious third-party entity. By using usage patterns, compromised accounts may be identified even when the malicious third-party entity is hidden and/or cannot be readily identified. Further discussion of account compromise detection techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

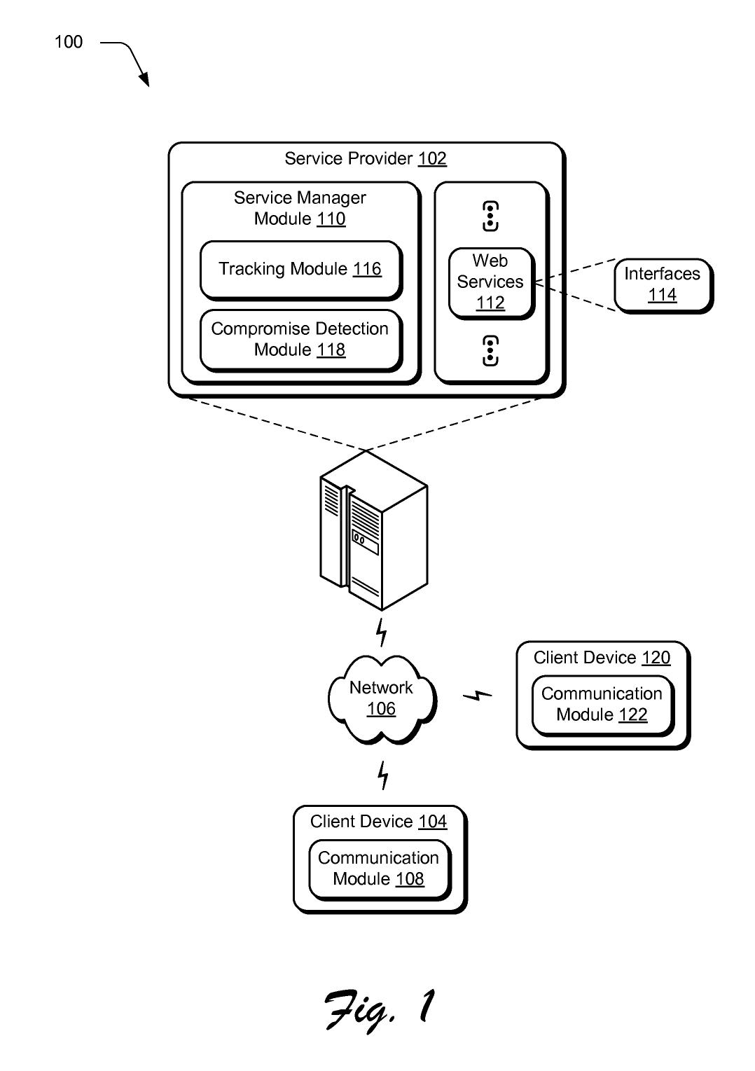

FIG. 1 is an illustration of an environment 100 in an example implementation that is operable to employ techniques described herein. The illustrated environment 100 includes a service provider 102 and a client device 104 that are communicatively coupled via a network 106. The client device 104 and the service provider 102 may be implemented by a variety of different configurations of computing devices.

For example, a client device 104 may be configured as a device that is capable of communicating over the network 106, such as a desktop computer, a mobile station, an entertainment appliance, a set-top box communicatively coupled to a display device, a wireless phone, tablet, a game console, and so forth. Thus, a client device 104 may range from full resource devices with substantial memory and processor resources (e.g., personal computers, game consoles) to a low-resource device with limited memory and/or processing resources (e.g., traditional set-top boxes, hand-held game consoles). Additionally, a client device 104 may be representative of a plurality of different devices, such as multiple servers utilized by a business to perform operations.

A client device 104 may also include an entity (e.g., software) that causes hardware of the client device 104 to perform operations, e.g., processors, functional blocks, and so on. For example, the client device 104 may include a computer-readable medium that may be configured to maintain instructions that cause the client device 104, and more particularly hardware of the client device 104 to perform operations. Thus, the instructions function to configure the hardware to perform the operations and in this way result in transformation of the hardware to perform functions. The instructions may be provided by the computer-readable medium to the client device through a variety of different configurations.

One such configuration of a computer-readable medium is signal bearing medium and thus is configured to transmit the instructions (e.g., as a carrier wave) to the hardware of the client device, such as via the network 106. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client device 104 is illustrated as including a communication module 108. The communication module 108 is representative of functionality of the client device 104 to communicate via the network 106, such as with the service provider 102. For example, the communication module 108 may incorporate browser functionality to navigate the network 106, may be configured as a dedicated application having network access functionality (e.g., obtained via an application marketplace accessible via the network 106), and so on.

The service provider 102 is illustrated as including a service manager module 110, one or more web services 112, and one or more interfaces 114 for accessing the web services 112. The service manager module 110 is representative of functionality of the service provider 102 to provide services via the network 106. One such service is illustrated as being provided using a tracking module 116. The tracking module 116 is representative of functionality of the service provider 102 to track user activity within a user account.

A variety of different information may be tracked using the tracking module 116. One example may include tracking a pattern of use that models user activity associated with the user account. This pattern, for instance, may represent a pattern of the web services 112 accessed and/or the interfaces 114 used to access the web services 112. In addition, the tracking module 116 may track a frequency with which the user accesses particular web services 112 and/or interfaces 114. In an implementation, transitions from one web service to another and/or from one interface to another are monitored. In addition, the tracking module 116 may monitor for changes to the user account. Also, the tracking module 116 may monitor protocols used and/or devices used to access the network or web services 112.

The information tracked by the tracking module 116 may be stored in an access profile for the user. The access profile, for instance, may include the usage pattern and subsequent activity associated with the user account. Thus, the access profile may represent a profile of activity within the user account, such as the web services 112 accessed, the interfaces 114 used to access the web services 112, the frequency and volume of interaction with the web services 112, and so on. Changes in the access profile can be monitored and used to determine the likelihood of account compromise.

The service provider 102 is further illustrated as including a compromise detection module 118. The compromise detection module 118 is representative of functionality of the service provider 102 to determine account compromise, such as suspicious activity within the user account. For example, the compromise detection module 118 may utilize the information gathered by the tracking module 116 to determine usage patterns of the user with respect to the user account. For instance, the compromise detection module 118 may determine which web services 112 and/or interfaces 114 are used by the user along with a frequency of such use. These usage patterns may then be utilized to determine suspicious activity associated with the user account. In this way, the compromise detection module 118 may determine a likelihood that a malicious third-party entity has gained access to and compromised the user account.

The service manager module 110 may also be configured to manage one or more web services 112 provided via the service provider 102. Web services 112 may include one or more software systems designed to support interoperable machine-to-machine interaction over the network 106. A variety of different web services 112 may be provided by the service provider 102, such as email or e-mail, short message service (SMS), multimedia messaging service (MMS), instant message (IM), and so on.

The web services 112 may be accessed via one or more interfaces 114 that enable communication with different client devices 104. The interfaces 114 may include a variety of different configurations, including by way of example and not limitation, interfaces configured for a mobile phone, a tablet, a desktop computer, a game console, and so on. Examples of different interfaces include different protocols, such as Simple Mail Transfer Protocol (SMTP) and Post Office Protocol (POP). Further discussion of different interfaces as well as different web services may be found in relation to the section titled “Communication Techniques.” Thus, a user may access a particular web service 112 via multiple different client devices 104, each configured for different interfaces 114.

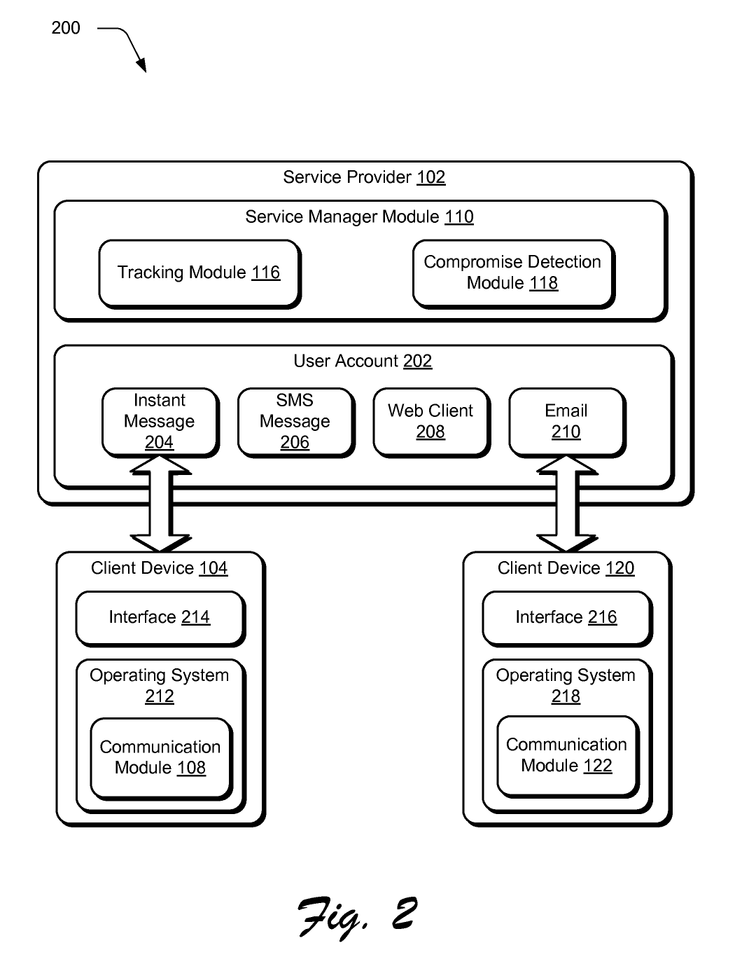

The environment 100 is further illustrated as including a second client device 120 with a communication module 122. The second client device 120 is representative of a third-party entity that may attempt to access the user account to cause suspicious and/or malicious activity. For example, an attacker or spammer may compromise a user email account by causing the user email account to send mass emails without user knowledge. Accordingly, through use of the compromise detection module 118 the service provider may protect a user's account from malicious parties, further discussion of which may be found in relation to FIG. 2.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of an environment 200 in an example implementation that is operable to employ account compromise detection techniques. The illustrated environment 200 includes a service provider 102 configured to maintain user accounts 202 for one or more users. The user account 202 may provide access to one or more web services (e.g., web services 112 illustrated in FIG. 1) that are provided by the service provider 102. Web services may include, by way of example and not limitation, an instant message 204 service, a SMS message 206 service, a web client 208 service, an email 210 service, and so on as previously described.

In addition, the client device 104 may include an operating system 212 that is configured to abstract functionality of underlying hardware of the computing device 104 (e.g., processors, functional blocks, and memory) to applications and other software that is executed on the computing device 104. Thus, the operating system 212 may interact with the communication module 108 to enable the client device 104 to communicate with one or more services provided by the service provider 102.

The client device 104 may utilize one or more interfaces 214 to interact with the web services provided by the service provider 102. For example, the client device 104 may be configured as a desktop computer to access the instant message 204 service using an interface that is configured for the desktop computer. Alternatively, the client device 104 may include a mobile phone that can access the email 210 service via an interface 214 configured for the mobile phone. Another example may include the SMS message 206 service accessed via a first interface configured for a mobile phone, later accessed via a second interface configured for a tablet, and then accessed yet again via a third interface configured for a desktop computer. In this way, a user may access one or more of the services associated with the user account 202 via any of a variety of interfaces 214 and/or client devices 104. Usage patterns that describe this access may then be used as a basis to determine whether a account has been compromised.

For example, the user account 202 may become compromised if a third-party entity (e.g., client device 120) gains access to the user account 202. Often, this third-party client device 120 can use the web services associated with the user account 202 for malicious purposes. The third-party client device 120 is illustrated as including an interface 216, an operating system 218, and a communication module 122. The third-party client device 120 may utilize these components when accessing and using the services associated with the user account 202. Often, usage of the user account 202 by the third-party client device 104 may occur without the knowledge of the user or the client device 104.

In implementations, the tracking module 116 may track user account 202 access patterns by monitoring which interfaces 214 are used to access which services, and a level of activity associated with each interface and/or service. This tracking information may be used by the compromise detection module 118 to determine a likelihood that the user account 202 may be compromised by a third-party entity (e.g., client device 120).

One example implementation of tracking the services that are frequently-used by a particular user may involve establishing a usage pattern for the particular user with the tracking module 116. This pattern may describe interaction with one or more of the web services. For example, the pattern may establish that the client device 104 frequently accesses the instant message 204 service, as illustrated in FIG. 2, but rarely accesses email 210 associated with the same user account 202. However, the compromise detection module 118 may determine that the increased use of email 210 is suspicious due to a level of email 210 use that substantially increases in comparison with the pattern. The increased use of email 210, for instance, may be associated with a third-party entity (e.g., client device 120 illustrated in FIG. 1) that has compromised the user account 202.

In implementations, a user may frequently use certain interfaces when accessing the web services. The tracking module may monitor these user habits to establish a usage pattern for the user. One example usage pattern may be established such that the user frequently accesses email 210 using a mobile phone interface 214 rather than an interface configured for another device. Responsive to a sudden transition of use to a different interface (e.g., interface 216), the compromise detection module 118 may determine that the transition is suspicious when compared to the usage pattern. The transition may include, for example, a transition from a mobile phone interface to a desktop interface.

In implementations, a transition to a different interface may or may not affect a footprint of the user on the network or over one or more web services 112. The footprint of the user may include a total sum of user actions associated with the user account 202. For example, use of the mobile phone interface may decrease proportionally to the increase in desktop interface usage. If the total sum of user actions (e.g., emails sent/viewed) subsequent to the transition to the desktop interface remains the same as prior to the transition, the compromise detection module 118 may determine that account compromise is not likely and that the transition is a normal or expected transition. This may be because although the user may use different devices to access the user account 202, total usage of the user account 202 may be more consistent and establish a more reliable pattern. Other implementations may include a transition to a different web service, but total usage of the user account 202 remains substantially constant. Thus, by considering normal or expected transitions, the compromise detection module 118 may determine that account compromise is not likely based at least in part on the total sum of user actions in the user account 202 remaining constant.

In additional implementations, the user account 202 may be accessed by a third-party entity (e.g., client device 120) using a same or similar web service and/or a same or similar interface as the user. Although in this instance, an interface transition is not detected, the tracking module 116 may track frequency and level of use of the web service to establish a usage pattern. Using this usage pattern, the compromise detection module 118 may determine that a sudden increase in account activity is suspicious. For example, responsive to the user's usage pattern establishing that the user accesses the web client 208 an average of two to five times in a day, and recent activity having increased to twenty to thirty times in a day, the compromise detection module 118 may determine that such an increase is suspicious.

Determining suspicious account activity using the usage patterns described herein may lead to a discovery that the user account 202 has been compromised. The compromise detection module 118 may thus determine the likelihood of compromise and then notify the user accordingly. In an implementation, the user may be presented with a cost proof or identity proof, an option to confirm a new usage pattern, and so on. A variety of other scenarios are also contemplated, further discussion of which may be found in relation to the following example procedures.

Example Procedures

The following discussion describes account compromise detection techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environments 100 and 200 of FIGS. 1 and 2, respectively.

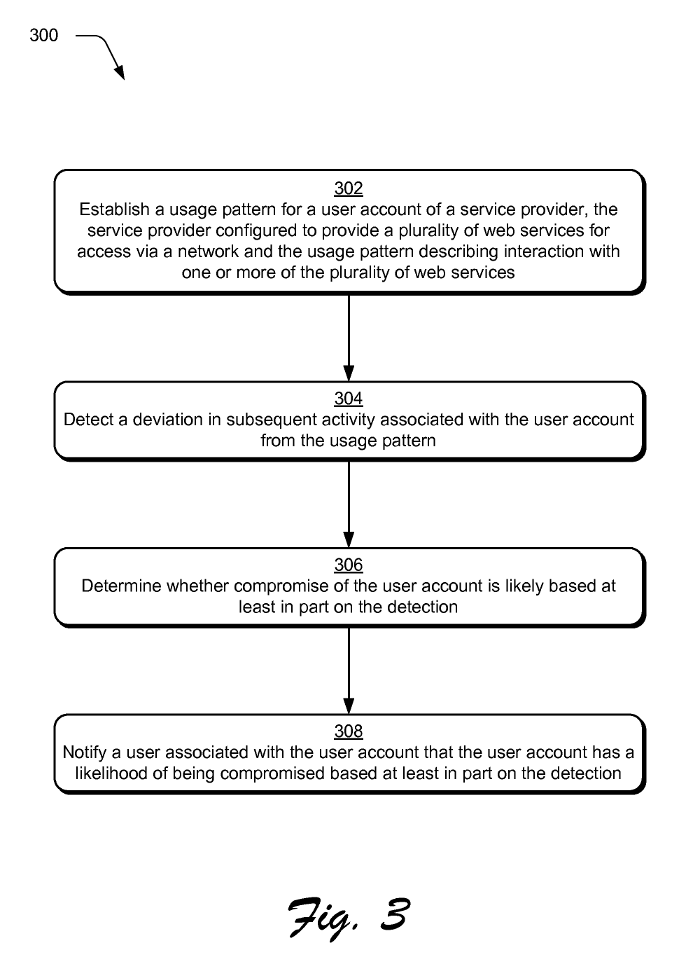

FIG. 3 depicts a procedure 300 in an example implementation of account compromise detection. A usage pattern is established for a user account of a service provider (block 302). The usage pattern, for instance, may be established by tracking activity associated with the user account 202 to ascertain a pattern of use associated with a user of the user account 202. The service provider 102, for instance, may be configured to provide a plurality of web services 112 for access via the network 106. The usage pattern may describe interaction with one or more of the web services 112 for the user account 202 as well as a frequency of access and/or a level of interaction with each of the web services 112. In addition, the usage pattern may indicate one a more interfaces 114 that are used to access respective web services 112.

In an implementation, the usage pattern may be associated with an access profile for the user. The access profile, for instance, may include the usage pattern and subsequent activity associated with the user account 202. Changes within the access profile may be monitored and used to determine compromise of the user account 202.

A deviation is detected in subsequent activity associated with the user account from the usage pattern (block 304). The deviation, for instance, may take a variety of forms, several of which are discussed herein. However, the example deviations discussed are merely examples and are not intended to be limitations.

The deviation, for instance, in the subsequent activity may include an increase in the volume of use of a respective web service based on the usage pattern. For example, the usage pattern may establish that a user accesses the email 210 service at a frequency of about ten to twenty times a week, whereas the subsequent activity may establish that the volume of use of the email 210 service has increased to about eighty to ninety times in a week.

In another instance, the deviation in the subsequent activity may include a transition to one or more interfaces 114 that are not described in the usage pattern. For example, the usage pattern may indicate that a user frequently accesses the email 210 service via an interface 114 configured for a smart phone, and rarely accesses the email 210 service otherwise. The deviation in the subsequent activity, however, may indicate that access to the email 210 service has transitioned to a different interface that is configured for a different device, such as a personal computer.

In another instance, the deviation in the subsequent activity may include a transition to one or more web services 112 that are not described in the usage pattern. The usage pattern, for instance, may describe frequent access to the instant message 204 service associated with user account 202, but may lack description of access to other web services. The deviation, however, in the subsequent activity may indicate a transition from frequent access of the instant message 204 service to frequent access of the email 210 service, which was not described in the usage pattern.

A determination is then made as to whether compromise of the user account is likely based at least in part on the detection of the deviation (block 306). The determination, for instance, may be based on evaluation of the deviation against various criteria. The criteria, for instance, may include a threshold (e.g., a degree of deviation from the usage pattern) so as to account for changes in user behavior. Other criteria may include a level of abuse of a new interface when a transition to the new interface is detected, a likelihood of a user transitioning from one interface to another (e.g., an instant message only user now becoming a heavy email user), and so forth. Responsive to determining a likelihood of compromise of the user account 202, the user may be notified (block 308).

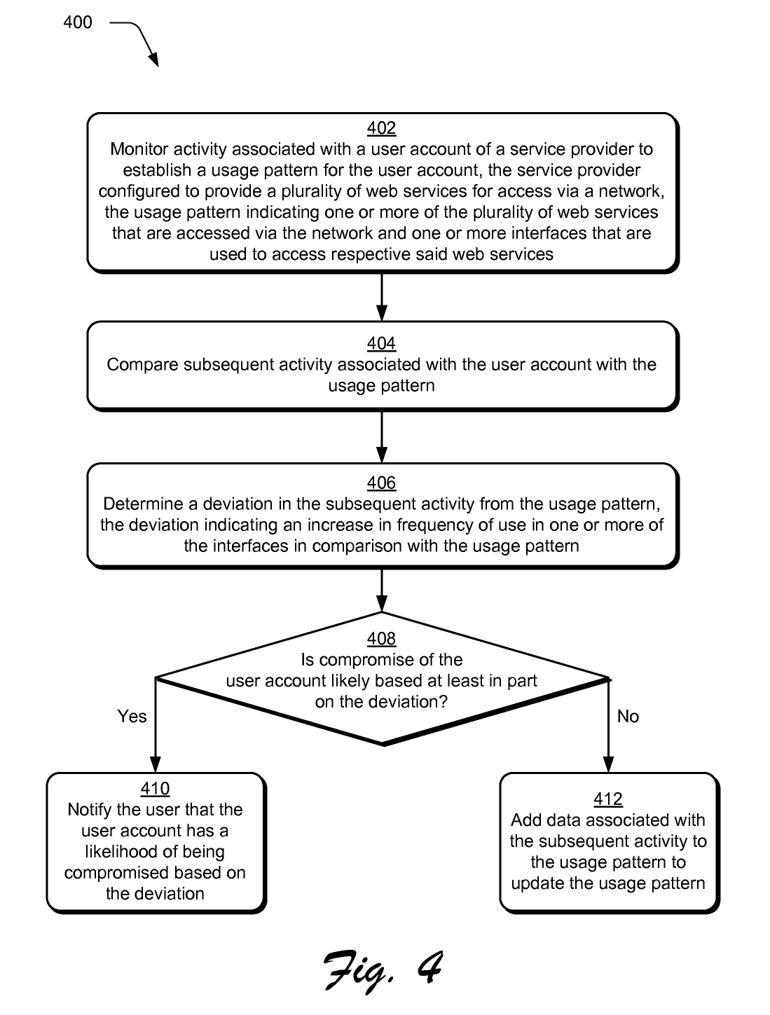

FIG. 4 depicts a procedure 400 in an example implementation that is operable to employ account compromise detection. Activity associated with a user account of a service provider is monitored to establish a usage pattern for the user account (block 402). The usage pattern, for instance, many indicate one or more of a plurality of web services 112 that are accessed via the network and one or more interfaces 114 that are used to access respective web services 112. The monitoring, for instance, of the activity associated with the user account 202 may be performed by the tracking module 116.

Subsequent activity associated with the user account is compared with the usage pattern (block 404). The subsequent activity, for instance, may include activity associated with the user account 202 that occurred subsequent to the establishment of the usage pattern. A comparison, for instance, of respective patterns indicated by the subsequent activity and the usage pattern, respectively, may indicate a variety of different scenarios. For example, the comparison may indicate that the subsequent activity is similar to the usage pattern, the subsequent activity minimally deviates from the usage pattern, the subsequent activity substantially deviates from the usage pattern, and so on.

A deviation is determined in the subsequent activity from the usage pattern, the deviation indicating an increase in frequency of use in one or more of the interfaces in comparison with the usage pattern (block 406). The usage pattern, for instance, may indicate that an interface configured for a handheld device is used to access one more web services 112 associated with the user account 202 an average number of times in a measurable period of time (e.g., hour, day, week, and so on). The deviation, however, in the subsequent activity may indicate a greater frequency of use than the average number of times indicated by the usage pattern. For example, the usage pattern may establish that the interface is used an average of fifty times per week, whereas the deviation may indicate that the interface has been used 150 times in a most-recent week. Such an increase in frequency of use of the interface may be indicative of a compromise to the user account 202.

A determination is made as to whether compromise of the user account is likely based at least in part on the deviation (decision block 408). As mentioned above, various criteria may be used to establish a threshold to determine whether the deviation in the subsequent activity constitutes a compromise to the user account 202. The criteria, for instance, can mitigate user changes which would lead to false positives. If the deviation is sufficient to surpass the threshold (“yes” from decision block 408), then the user account 202 has likely been compromised. If, however, the deviation is not sufficient to surpass the threshold (“no” from decision block 408), but instead remains within the threshold, then the user account 202 has likely not been compromised.

For example, the threshold may be established by a pattern of a total sum of user activity within the user account 202. Continuing with the above example, the deviation that includes an increase in frequency of use of the interface configured for a handheld device may also include a proportionally decreased usage of a different interface configured for a different device. Thus, the decreased usage of the different interface may offset the increase in frequency of use of the handheld device's interface, indicating that the overall usage of the user account 202 has remained substantially constant. In this example, the compromise detection module 118 may determine that the user account 202 has likely not been compromised.

Responsive to a determination that the user account has a likelihood of being compromised based on the deviation (“yes” from decision block 408), the user is notified (block 410). The user may be notified, for instance, by presenting the user with a cost proof or identity proof. These proofs may include information describing, for instance, the activity associated with the user account that is suspicious, the deviation in the subsequent activity, the likelihood of account compromise, and so on. In addition, the user may be presented with a selectable option to establish a new usage pattern. In this way, the user may confirm that the deviation is attributed to the user and not associated with a third-party entity.

Responsive to a determination that the deviation is not associated with compromise of the user account(“no” from decision block 408), data associated with the subsequent activity is added to the usage pattern to update the usage pattern (block 412). Although the subsequent activity, for instance, may deviate from the usage pattern, the deviation may still remain within the threshold established by the various criteria. For example, relatively small deviations (e.g., deviations remaining within the threshold) may indicate a change in user behavior rather than activity by an unauthorized third-party entity. For example, the user may have begun accessing the user account via a different device or begun using a different web service, but overall user activity (e.g., messages sent/viewed) within the user account has remained consistent with the pattern established prior to the change to the different device or web service. Thus, data associated with these relatively small deviations may be added to the usage pattern to update the usage pattern so as to include the changes in the user's behavior. This updated usage pattern may then be used when determining compromise of the user account 202 against further subsequent account activity.

Communication Techniques

The following provides further examples of web services that may be accessed through the user account of the service provider and employed to deliver a message to a communication device as well as transmit the message by the communication device.

Web Service

Electronic messages may be sent and received via a web service. A web service may include a software system designed to support interoperable machine-to-machine interaction over a network. A web service may have an interface described in a machine-processable format, such as Web Services Description Language (WSDL). Other systems may interact with the web service in a manner prescribed by the web service's WSDL. Implementations of web services include web-based email services and/or web-based IM services. Web based services may include Extensible Markup Language (XML) messages that follow a Simple Object Access Protocol (SOAP) standard. Other web services may include Web Application Programming Interfaces (Web API), which may include a set of Hypertext Transfer Protocol (HTTP) request messages along with a definition of the structure of response messages.

Web services may be used in a number of ways. Some example uses include Remote Procedure Calls (RPC), Service-Oriented Architecture (SOA), and Representational State Transfer (REST).

Instant Messaging

Instant messaging is a popular text-based communication tool that enables two or more users to exchange messages via a network during an instant messaging session. When two users are online at the same time, for instance, instant messages may be exchanged in real time between the two users. Thus, the instant messages may be utilized to support a text conversation between the two users in a manner that mimics how the two users would participate in a typical spoken conversation.

Instant messaging is typically based on clients that facilitate connections between specified known users. Often, these known users can be associated with a “buddy list” or “contact list.” Although instant messaging is text-based, instant messaging may include additional features such as audio and/or video. For example, during an instant messaging session, users can see each other by using webcams or other video cameras, and/or hear each other using microphones and speakers.

In an implementation, instant messaging (IM) modules communicate with each other through use of one or more of a plurality of service providers. A service provider, for instance, may include an IM manager module, which is executable to route instant messages between the IM modules. For example, a client may cause the IM module to form an instant message for communication to a recipient. The IM module is executed to communicate the instant message to the service provider, which then executes the IM manager module to route the instant message to the recipient over the network. The recipient receives the instant message and executes the IM module to display the instant message.

Clients can also be communicatively coupled directly, one to another (e.g., via a peer-to-peer network). If so, the instant messages are communicated without utilizing the service provider.

SMS/MMS

Short Messaging Service (SMS) is communication tool that allows an exchange of short text messages between a fixed line or mobile phone device and fixed or portable devices over a network. Unlike instant messaging, SMS messages can be transmitted without both the sender and receiver being simultaneously online. SMS messages may be sent to a Short Message Service Center (SMSC), which may provide a store and forward mechanism. The SMSC may then attempt to send the SMS messages to intended recipients. If a recipient cannot be reached, the SMSC may queue the SMS message and retry at a later time. Some SMSCs, however, may provide a forward and forget option where transmission is attempted only once.

In addition to text, SMS techniques have been expanded to include Multimedia Messaging Service (MMS) which allows the exchange of multimedia content along with the short text messages. Multimedia content may include digital photographs, videos, and the like.

Although MMS messages are similar to SMS messages, MMS messages are delivered in an entirely different way. For example, the multimedia content in the MMS message is first encoded in a manner similar to a Multipurpose Internet Mail Extension (MIME) email. The encoded MMS message is then forwarded to a Multimedia Messaging Service Carrier (MMSC), which is a carrier's MMS store and forward server. If the intended recipient is associated with a different carrier, the MMSC may forward the encoded message to the recipient's carrier using the Internet.

Once the MMSC has received the message, it may determine whether the recipient's device is configured to receive an MMS message. If the recipient's device is MMS capable, then the content is extracted and sent to a temporary storage server with a Hypertext Transfer Protocol (HTTP) front-end. An SMS control message containing a Uniform Resource Locator (URL) of the MMS content may then be sent to the recipient's device to trigger the recipient device's Wireless Access Protocol (WAP) browser to open and receive the MMS content from the URL. If, however, the recipient device does not support MMS messages, the MMSC may attempt to modify the MMS content into a format suitable for the recipient device before sending the MMS content to the recipient device.

Electronic Mail

Electronic mail, commonly referred to as email or e-mail, is a communication tool for exchanging digital messages from an author to one or more recipients over a network. A user can send an email message through his or her email program, which sends the email message to a mail server. The mail server may then forward the email message to another mail server or to a message store on the same mail server to be forwarded later.

Email messages include an envelope, a header, and a body. The header may include fields that have names and values. Some example fields include From, To, CC, Subject, Date, and other information about the email message. The body may include basic content of the email message, as unstructured text, and may also include a signature block. The envelope is used to store communication parameters for delivery of the email message.

Email is one of the protocols included with the Transport Control Protocol/Internet Protocol (TCP/IP) suite of protocols. An example popular protocol for sending email is Simple Mail Transfer Protocol (SMTP), whereas example popular protocols for receiving emails include Post Office Protocol 3 (POP3) and/or Internet Message Access Protocol (IMAP). TCP/IP can be used as a communication language or protocol of the Internet, an intranet, or extranet. When an email message is sent over a network, the TCP manages assembly of the message or file into smaller packets, also referred to as “packetizing” the message. These packets are transmitted over the network, such as the Internet, and received by a TCP layer that reassembles the packets into the original message. The IP layer handles the address portion of each packet to ensure that each packet reaches the correct destination.

Interoperability of Electronic Communication

In some implementations one communication tool may be used within another. For example, email messages may be sent and/or received from within a web service. In addition, SMS messages may be sent using an email application and/or an IM application. In another example, as mentioned above, a web service may provide web-based email services and/or a web-based IM services.

Conclusion

Although embodiments have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method implemented by one or more computing devices, the method comprising:
establishing a usage pattern for a user account of a service provider, the service provider configured to provide a plurality of web services for access via a network and the usage pattern describing interaction with one or more of the plurality of web services;
detecting a deviation in subsequent activity associated with the user account from the usage pattern; and
determining whether compromise of the user account is likely based at least in part on the detection.

2. A method as recited in claim 1, wherein the establishing of the usage pattern comprises tracking activity associated with the user account, the usage pattern indicating the web services that are accessed via the network.

3. A method as recited in claim 1, wherein the usage pattern indicates one or more interfaces that are used to access respective said web services.

4. A method as recited in claim 3, wherein the deviation in the subsequent activity comprises a transition to one or more said interfaces that are not described in the usage pattern.

5. A method as recited in claim 1, wherein the deviation in the subsequent activity comprises an increase in volume of use of a respective said web service based on the usage pattern.

6. A method as recited in claim 1, further comprising notifying a user associated with the user account that the user account has a likelihood of being compromised based at least in part on the detection.

7. A method as recited in claim 1, wherein the deviation in the subsequent activity comprises a transition to one or more said web services that are not described in the usage pattern.

8. A method as recited in claim 1, wherein the detecting of the deviation in the subsequent activity is performed by an account detection module.

9. A method as recited in claim 1, further comprising:
determining that the deviation is not associated with compromise of the user account; and
updating the usage pattern by adding data associated with the subsequent activity to the usage pattern.

10. A method implemented by one or more computing devices, the method comprising:
monitoring activity associated with a user account of a service provider to establish a usage pattern for the user account, the service provider configured to provide a plurality of web services for access via a network, the usage pattern indicating one or more of the plurality of web services that are accessed via the network and one or more interfaces that are used to access respective said web services;
comparing subsequent activity associated with the user account with the usage pattern;
determining a deviation in the subsequent activity from the usage pattern, the deviation indicating an increase in frequency of use in one or more of the interfaces in comparison with the usage pattern; and
determining whether compromise of the user account is likely based at least in part on the deviation.

11. A method as recited in claim 10, wherein the monitoring of the activity associated with the user account is performed by a tracking module.

12. A method as recited in claim 10, further comprising notifying the user that the user account has a likelihood of being compromised based on the deviation.

13. A method as recited in claim 10, further comprising determining that the increase in frequency of use in the one or more of the interfaces is associated with a malicious entity that has compromised the user account.

14. A method as recited in claim 10, further comprising:
determining that the deviation is not associated with the compromise of the user account; and
adding data associated with the subsequent activity to the usage pattern to update the usage pattern.

15. A method as recited in claim 10, wherein the determining of the deviation in the subsequent activity is based at least in part on criteria including at least one of a level of abuse of the one or more of the interfaces or a likelihood of a user transitioning to the one or more of the interfaces from one or more different interfaces that are described in the usage pattern.

16. A compromise detection module implemented at least in part by hardware, the compromise detection module configured to:
compare an established usage pattern associated with a user account of a service provider to subsequent activity associated with the user account, the service provider configured to provide a plurality of web services for access via a network and the established usage pattern indicating one or more of the plurality of web services that are accessed via the network;
detect, in the subsequent activity, an increase in volume of usage of one or more of said web services based on the established usage pattern;
determine whether compromise of the user account is likely based at least in part on the detection.

17. A compromise detection module as recited in claim 16, wherein the subsequent activity includes an increase in frequency of usage of one or more interfaces that are used to access respective web services based on the established usage pattern.

18. A compromise detection module as recited in claim 16, wherein the subsequent activity indicates use of one or more interfaces that are not described in the established usage pattern and are used to access the one or more of said web services.

19. A compromise detection module as recited in claim 16, wherein the compromise detection module is further configured to present a notification to a user associated with the user account to notify the user that the user account has a likelihood of being compromised based on the detection.

20. A compromise detection module as recited in claim 16, wherein the compromise detection module is further configured to:
determine that compromise of the user account is not likely, and
cause the usage pattern to be updated by adding data associated with the subsequent activity to the established usage pattern.
